(19) United States
(12) Patent Application Publication
(10) Pub. No.: US 2012/0054731 A1
(43) Pub. Date: Mar. 1, 2012

(54) Method, System and Computer Programs to Assist Migration to a Cloud Computing Environment

(75) Inventors: Nishanth Aravamudan, Portland, OR (US); Karen Cheng, Markham (CA); Robert Filepp, Westport, CT (US); Robert D. Kearney, Yorktown Heights, NY (US); Markus Klems, San Francisco, CA (US); Brian L. Peterson, Ridgefield, CT (US); Larisa Shwartz, Scarsdale, NY (US); Christopher Ward, Glen Ridge, NJ (US); Christopher Charles Young, Sleepy Hollow, NY (US)

(73) Assignee: International Business Machines Corporation, Armonk, NY (US)

(21) Appl. No.: 13/214,489

(22) Filed: Aug. 22, 2011

Related U.S. Application Data
(60) Provisional application No. 61/376,457, filed on Aug. 24, 2010.

(51) Int. Cl. G06F 9/44

(52) U.S. Cl. 717/170

(57) ABSTRACT

Disclosed is a computer-implemented method, system and computer program(s) for migration of a source machine instance to a target machine instance of least one heterogeneous virtual server device managed within a cloud computing environment. The method includes discovering machine images of a cloud service provider and storing results in a computer-readable catalog containing cloud metadata comprised of machine image identifiers and information discovered about the machine images. The method further includes, in response to a request for migration document in a computer-readable form that comprises a specification of a required migration target machine instance, specifying weight/priority information for components to be included in the target machine instance, where the weight information indicates weights for operations comprising component installation, component removal and component upgrade in the target machine instance. The method also includes executing a best fit matching algorithm to examine the catalog in accordance with the weight/priority information to identify optimal machine images to be used for the migration of the source machine instance to the target machine instance.

### CROSS-REFERENCE TO RELATED APPLICATIONS

This patent application claims priority under 35 U.S.C. §119(e) from U.S. Provisional Patent Application No. 61/376,457, filed Aug. 24, 2010, the disclosure of which is incorporated by reference herein in its entirety.

### TECHNICAL FIELD

The exemplary embodiments of this invention relate generally to computing services, and more particularly to improving the determination of optimal target machine images for migration of a workload to a cloud computing environment, and to tools to assist in the migration of a workload to optimal machine instances hosted by a cloud computing service.

### BACKGROUND

Advances in a virtualization technology and mainframe hardware have made a consolidation of applications onto a fewer number of centralized servers very attractive. However, a process of planning and performing such a migration is time-consuming, costly, and prone to an error. A risk is also involved in the migration process due to a high degree of complexity of applications deployed on server devices. For example, consider a large number of distributed applications (e.g., 1 million applications) that can be deployed on server devices. One server device could host an application on a middleware product to meet performance and high availability requirements. That application may be distributed over several server devices. This distributed application may require a database which is deployed on another server device. Messaging components to support information exchange with other internal or external applications may require a set of server devices and be deployed to several application servers. A consolidation of this set of servers may require an in-depth knowledge of configurations of the set of servers and an insight into how to best plan and run a migration of source applications to the final target platform

A cloud service provider offers a set of pre-configured systems (e.g., a virtual machine (VM) image with operating system (OS)). The cloud service users use these systems to create and/or modify software environments that host end-user applications and services.

Cloud computing service providers generally do not expose complete details in a computer readable manner regarding the configuration of the images that they provide. For example, one provider enables a user to search or browse their inventory of machine images, but they do not expose an application programming interface (API) to allow third-party computer programs to search the inventory of machine images for images that meet specific criteria. This means that in order to find a “best fit” machine image to instantiate, a human user must manually examine potentially thousands of machine image descriptions to evaluate their suitability as a platform to host a source application. Furthermore the descriptions of the content of images cloud computing service providers offer very little, if any, information that is meaningful without a priori knowledge on the part of the user. For example, one cloud service provider provides image names limited to 128 characters, while the associated description is limited to 255 characters.

One conventional example of a command for creating an image and describing same for future identification is as follows:

PROMPT> ec2-create-image i-10a64379 —name “Standard Web Server” —description “Standard web server AMI” IMAGE ami-4fa54026″

Neither the name “Standard Web Server” nor the description “Standard web server AMI” provide sufficient information, without a priori knowledge, to enable a user to determine if the image will meet the needs of the user. A “Standard web server AMI” might be run on any of a number of operating systems. A “Standard web server AMI” might have any storage capacity and processing speed. A “Standard web server AMI” might provide support for PHP (hypertext pre-processor), and/or support for a database, and/or support for servlets, and/or secure transactions, and/or any number of things. In most cases of interest the detail needed to determine the suitability of an image cannot be expressed in a meaningful way to the user with 255 characters. This is especially true since neither the image descriptions nor names conform to rigorous conventions.

Furthermore both the names and descriptions of the images are entered by a human and there are no guarantees that the text entered describes the actual content of the image.

Once a user has identified a suitable machine image, the user must instantiate it and install any additional required software on top of the instance, and potentially also re-configure installed software. For example, if a machine instance with a database is required and none is available, the user may need to create a user account for the database administrator on the target instance operating system, then install the database to the instance, and then enable the database administrator account to manage the database.

Tools and methods to discover the configuration of computer systems are well known. An example of a discovery toolset is IBM® Tivoli® Change and Configuration Management Database Configuration Discovery and Tracking (IBM and Tivoli are registered trademarks of International Business Machines Corporation).

Identifying suitable target machine instances, and insuring that they are properly and completely provisioned and configured, can be a tedious and costly task.

Therefore a need exists to provide computer automated tooling in order to reduce the manual effort required to prepare for the migration of an application to a cloud computing environment.

### SUMMARY

The foregoing and other problems are overcome, and other advantages are realized, in accordance with the exemplary embodiments of this invention.

In a first aspect thereof the exemplary embodiments provide a computer-implemented method for migration of a source machine instance to a target machine instance of least one heterogeneous virtual server device managed within a cloud computing environment. The method comprises discovering machine images of a cloud service provider and storing results in a computer-readable catalog containing cloud metadata comprised of machine image identifiers and information discovered about the machine images. The method further comprises, in response to a request for migration document in a computer-readable form that comprises a specification of a required migration target machine instance, specifying weight/priority information for components to be included in the target machine instance, where the weight information indicates weights for operations comprising component installation, component removal and component upgrade in the target machine instance. The method also comprises executing a best fit matching algorithm to examine the catalog in accordance with the weight/priority information to identify optimal machine images to be used for the migration of the source machine instance to the target machine instance.

In a further aspect thereof the exemplary embodiments provide a computer-readable storage medium containing program instructions that, when executed by at least one data processor, result in performing operations to migrate a source machine instance to a target machine instance of least one heterogeneous virtual server device managed within a cloud computing environment. The operations comprise discovering machine images of a cloud service provider and storing results in a computer-readable catalog containing cloud metadata comprised of machine image identifiers and information discovered about the machine images; in response to a request for migration document that comprises a specification of a required migration target machine instance, specifying weight/priority information for components to be included in the target machine instance, where the weight information indicates weights for operations comprising component installation, component removal and component upgrade in the target machine instance; and executing a best fit matching algorithm to examine the catalog in accordance with the weight/priority information to identify optimal machine images to be used for the migration of the source machine instance to the target machine instance.

In another aspect thereof the exemplary embodiments provide a system configured to migrate a source machine instance to a target machine instance of least one heterogeneous virtual server device managed within a cloud computing environment. The system includes at least one computer-readable storage medium storing computer program instructions and at least one data processor readably coupled to the at least one computer-readable storage medium. In the system execution of the computer program instructions by the at least one data processor causes the at least one data processor to discover machine images of a cloud service provider and store results in a computer-readable catalog containing cloud metadata comprised of machine image identifiers and information discovered about the machine images. The at least one data processor is responsive to a request for migration document that comprises a specification of a required migration target machine instance, to specify weight/priority information for components to be included in the target machine instance, where the weight information indicates weights for operations comprising component installation, component removal and component upgrade in the target machine instance. The at least one data processor is further configured to execute a best fit matching algorithm to examine the catalog in accordance with the weight/priority information to identify optimal machine images to be used for the migration of the source machine instance to the target machine instance.

In yet another aspect thereof the exemplary embodiments provide a computer-executed method to migrate a target machine instance to a cloud computing environment. The method comprises discovering machine image components of machine images of a cloud service provider and storing results in a computer-readable inventory; removing from consideration those machine images having hardware and software that is incompatible with the target machine instance; and executing a best fit matching algorithm to compare a sorted list of machine image software components for a particular machine image and a sorted list of software components of the target machine instance to derive a cumulative cost for implementing the sorted list of target machine software components as a particular instance of the machine image software components.

### BRIEF DESCRIPTION OF THE SEVERAL VIEWS OF THE DRAWINGS

FIG. 1A is a logic flow diagram, and FIG. 1B a block diagram, of an exemplary embodiment of a method, system and computer programs to assist in the migration of a computer-based workload source application to a cloud environment target application.

FIG. 2 illustrates the Step 1 of FIG. 1A and certain blocks of FIG. 1B in greater detail.

FIG. 3 is another, more detailed view of the components and system shown in FIG. 1B.

FIG. 4 depicts an example cost policy in table form.

FIGS. 5 and 6A and 6B (collectively referred to as FIG. 6) are logic flow diagrams that show the operation of a matching algorithm.

FIG. 7A is an overall view of a system that incorporates the exemplary embodiments of this invention and its interface(s) with a cloud service provider.

FIG. 7B is a simplified block diagram of the system shown in FIG. 7A.

FIG. 7C illustrates a logical data model that is representative of the system shown in FIG. 3.

FIG. 8 shows an exemplary sorting operation for image and target middleware (software).

### DETAILED DESCRIPTION

By way of an introduction, within the scope of application migration (to the cloud) “discovery” is used to assess the user's computer systems and computer system configurations. “Discovery” supports the user to understand the current status of the user's infrastructure and software. With this information the user can create a “Request for Migration” (RFM) document that specifies the infrastructure (hardware) and software that the user wishes to have instantiated in the post-migration information technology (IT) landscape. The RFM is passed to a provisioning manager which performs infrastructure and software provisioning, after which the application migration and testing is performed.

The current state of the art in migration from a source platform to a cloud environment is that only virtual machines (VM) can be migrated to cloud environments, and the source VM must be of the same kind supported by the cloud environment. Currently tooling to assist the migration of applications and systems “into the cloud” comes with restrictions on both the source systems and the target system environment (provided by the cloud). This is due to the fact that known migration and management approaches are VM-based.

As one example, it is possible to use VMware® (VMware is a registered trademark of VMWare, Inc.) migration tools to migrate VMs that have been created with VMware into a cloud that provides an environment for VMware® VMs. Therefore the migration process depends on the cloud service provider supporting the VMware® hypervisor. For example, it is not possible to upload VMware® VMs into a cloud of a provider who uses a different type of virtualization.

In order to migrate physical computer systems into a cloud that contains a set of VMs, the physical systems must first be transformed into VMs. These transformation capabilities, again, depend on the virtualization technology tooling. Furthermore, with these approaches it is not possible to “upgrade” or “downgrade” hardware and software during migration.

It would thus be useful to be able to migrate just those hardware and software platform components upon which an application depends, without migrating an entire VM, to enable the application to be migrated to a heterogeneous target platform in a cloud environment, and to enable upgrades, downgrades and other configuration customization of the target hardware and software components upon which the migrated application will depend.

Further, currently when replicating computer systems and software configurations in the cloud the user must find the most suitable systems provided by the cloud service provider, and then manually provision the infrastructure and manually install the required software on top of the infrastructure. Even if the installation procedure could be automated using existing tools, the user must still search for and locate the most suitable computer system provided by the cloud service provider, and then compare the located system it to the user's source system. If the cloud service provider offers a large number of computer systems, locating a suitable system can require considerable effort on the part of the user.

It would thus also be useful to provide tooling in order to reduce the manual effort required to prepare for the migration of an application to the cloud environment.

As a non-limiting example: consider migration of an application that is hosted on a System P/AIX computer to a Xen-x86 Virtual Machine with Linux that is offered by IBM RC2. The method makes use of an RFM document and can therefore be integrated into existing migration workflows. In particular, it is possible to provide a self-service interface to the user that enables the user to specify a target system or systems that the user wishes to use, and that enables the user to compare the source systems to the target systems in a coherent fashion. The user is not required to search the available computer systems offered by the cloud service provider and attempt to manually match between the source system(s) and the cloud service provider's target systems. Instead, the user defines the desired target system (RFM) and then enables the automated system to locate a match between the RFM and the available resources from the cloud service provider.

The RFM document contains information descriptive of the hardware and software of the systems that the user wishes to have after the migration has taken place. It can be assumed that the description expressed in the RFM document cannot directly be processed by the cloud service provider, who has only a limited set of computer systems.

An exemplary aspect of this invention is a procedure and method, which may be referred to without a loss of generality as an algorithm, to match the RFM with the hardware of the computer systems of the cloud service provider. The output of the algorithm indicates “success” or “failure”. In case of “success”, the cloud service provider can offer a computer system with the requirements specified in the RFM. In the case of “failure”, at least one of the requirements specified in the RFM could not be fulfilled. In this case the user can either select a system with a different hardware setting than the one specified in the RFM, or the user can employ an alternative migration mechanism.

In accordance with an exemplary aspect of this invention an algorithm matches the RFM with the software that can be on-boarded onto (instantiated upon) computer systems of the cloud service provider. Again, the output of the algorithm indicates “success” or “failure”.

The user can decide between a traditional provisioning process and the provisioning of resources through a cloud service provider. The choices have attributes, for example, “speed of migration”, “accuracy of provisioned target system with respect to the RFM document”, etc. These attributes are made known to the user who can then make an informed decision on the provisioning mechanism to use.

In one illustrative algorithm the source architecture specifications are used as an ‘at least’ match on the set of images maintained by the cloud service provider. That is, the set of attributes for the images available on the cloud are gathered using one of the cloud APIs and are used as minimal preconditions for selection of a viable target image. For example, if the user's CPU, memory and disk requirements are 1000Mips, 2 GB and 500 GB, respectively, those images that support at least these requirements are candidates. Of these, the least image in accordance with some criteria (e.g., based on difference of steady state running cost of the images as advertised by the service provider, or based on the least disk capacity, followed by memory, followed by CPU) is selected. If no candidate image is available then the algorithm output is ‘failure’.

This approach is independent of the computer system architectures and virtualization technologies on both the user side and on the cloud service provider side. Furthermore, this approach allows defining a RFM without knowledge of the computer systems offered by the cloud service provider.

The output is a set of computer system instances that are deployed in the administrative domain of the cloud service provider and that can be accessed by the user. Additionally, a report can be delivered to the user to show the results of the migration process.

An aspect of this invention is to provide an ability for a cloud service provider to offer an automated migration method that allows users to on-board their existing applications and services. Automation of the on-boarding process reduces the required human tasks in the workflow and thereby improves reliability and reduces cost. In general, the exemplary embodiments of this invention may be offered as a value-added service by a cloud service provider or by a third party service provider.

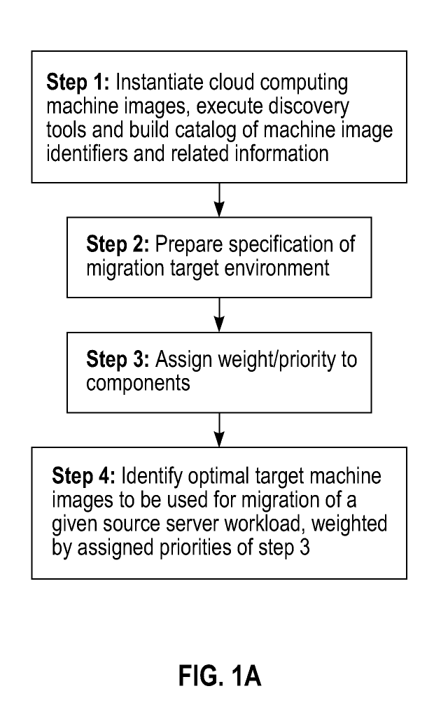

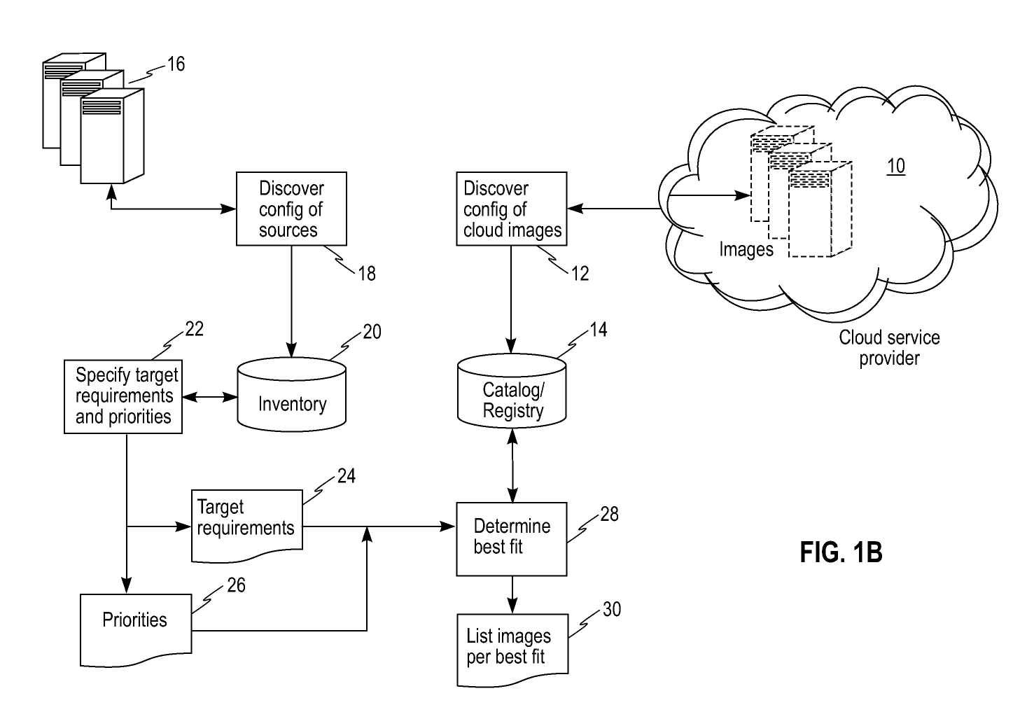

Reference can be made to FIGS. 1A and 1B for providing an overview of the operation of the exemplary embodiments. Note that in FIG. 1A the first three steps could be performed in other than the order indicated, and at least some of these steps might be performed in parallel.

In a first step (Step 1) cloud computing machine images of a cloud service provider 10 are instantiated by whatever means the cloud service provider makes available. Discovery tools 12 are loaded onto the machine instances. Discovery tools are executed and the results are returned to an external application which builds a catalog 14 containing cloud metadata comprised of machine image identifiers and the information discovered about the machine images. In one embodiment the catalog 14 may be stored within a relational database to facilitate searching the catalog.

Step 2: asynchronously to operation of step 1, a specification of the required migration target environment 16 is prepared in a computer-readable form. In an exemplary embodiment this can be assisted by the application of discovery tools 18 against proposed migration source servers, returning results to an inventory 20 containing the source server identifiers and the information discovered about the source servers.

Step 3: asynchronously to the steps 1 and 2, some entity, which may be a human or some expert system software, assigns a weight/priority to components that may be included in a target machine instance, indicating weights for operations such as component installation, removal, and upgrade. This step involves the specification 22 of target requirements 24 and priorities 26.

Step 4: once the above steps have been performed, an algorithm (determine best fit algorithm 28) is executed to examine the catalog 14 to identify the optimal target machine images 10 to be used for the migration of the given source server workload (16, 18), as specified by the requirements 24, weighted by the priorities 26. The output is a list of images per best fit 30, which can be displayed to a user and/or stored for later use.

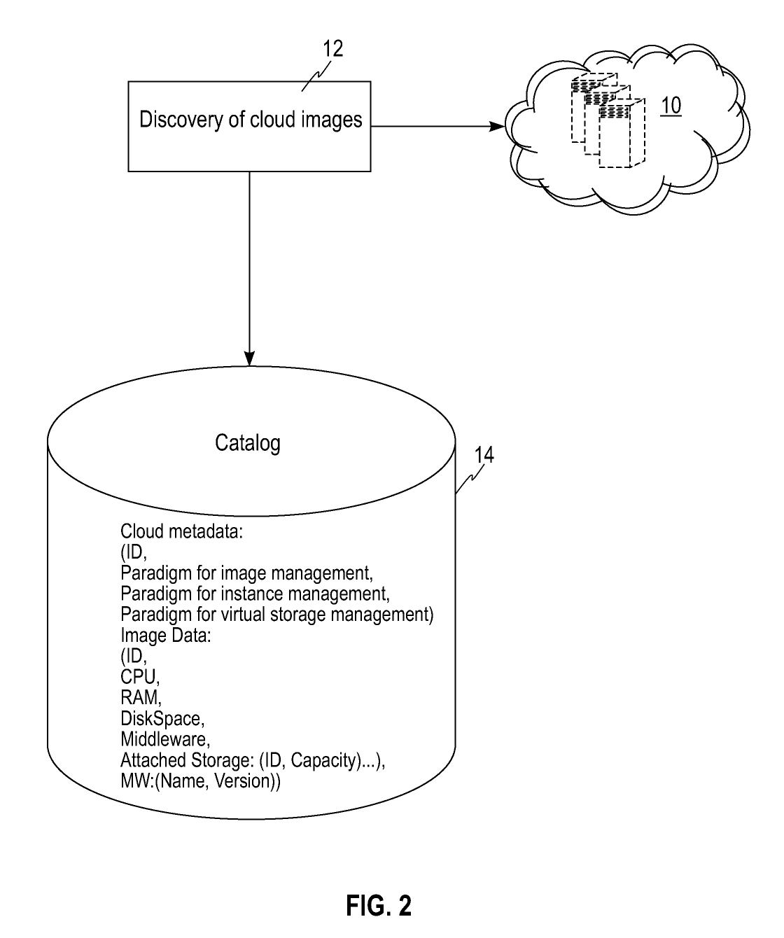

FIG. 2 illustrates the Step 1 of FIG. 1A and blocks 10, 12 and 14 of FIG. 1B in greater detail. At the completion of the discovery operation 12 the catalog 14 can be seen to include the cloud metadata. One exemplary and non-limiting format of the cloud metadata is as follows:

### {ID,

Paradigm for image management,
Paradigm for instance management,
Paradigm for virtual storage management}

### Image Data:

### (ID,

### CPU,

### RAM,

### DiskSpace,

### Middleware (MW),

### Attached Storage: (ID,Capacity) . . . . ),

### MW:{NAME, VERSION}}.

Note that the specific format and content of the cloud metadata can typically be a function of a particular cloud service provider. Note further that as employed herein “Middleware” can be assumed to include software such as application software and network software, and any other executable software that is desirable to include in the instantiation of the target computer system in the cloud 10.

An aspect of the exemplary embodiments of this invention is to provide a service that accumulates image configuration details in a canonical fashion, and a further service that employs an algorithm to order images per best-fit/least cost in conformance with user-specified policies. These services collectively facilitate workload transformation into enterprise cloud environments.

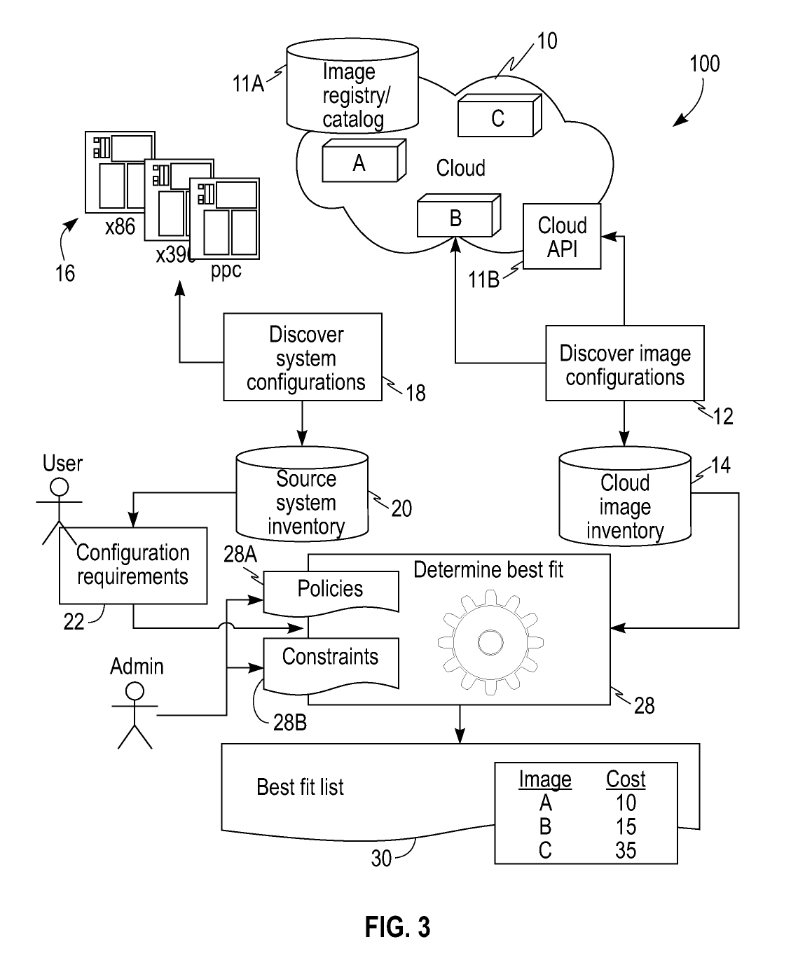

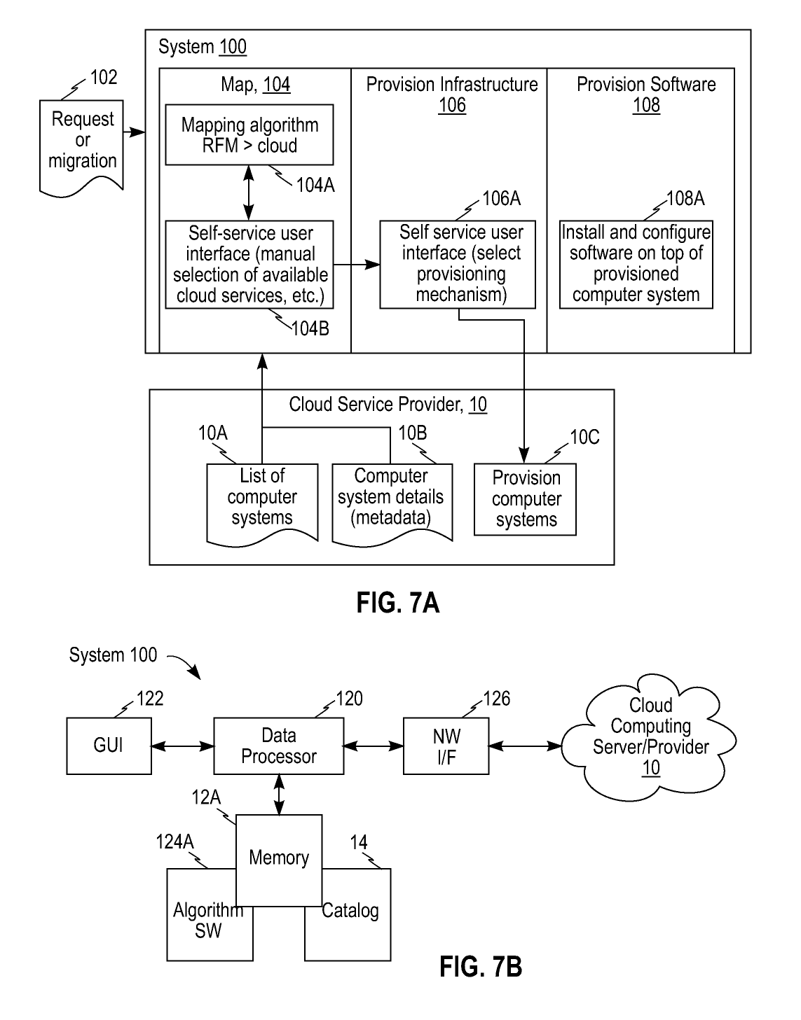

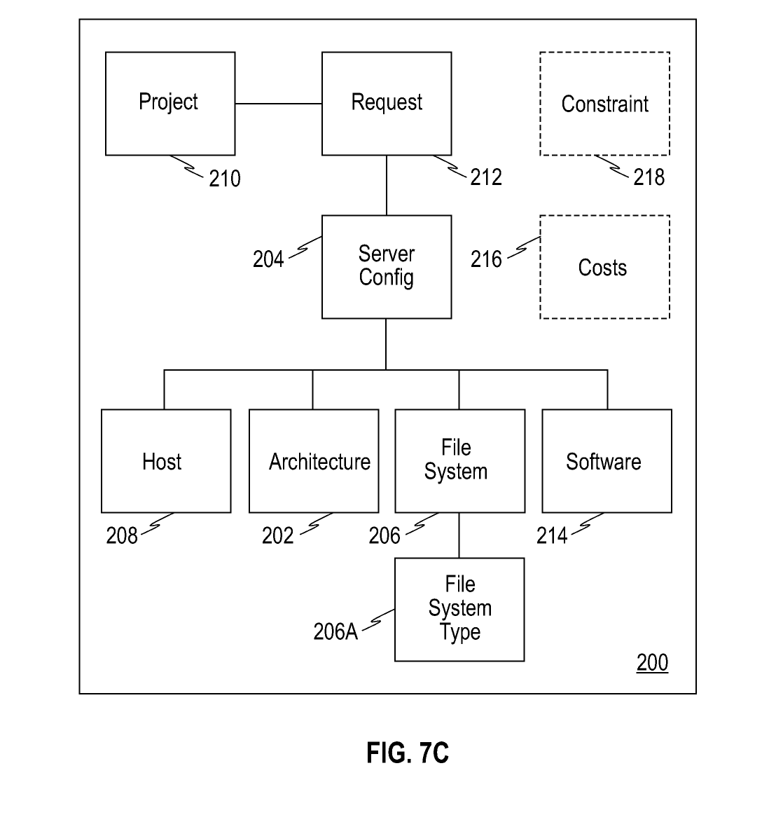

FIG. 3 is another, more detailed view of the components shown in FIG. 1B, and illustrates at a high level a system 100 (described in further detail below with respect to FIGS. 7A and 7B) that involves three actors: an administrator (a “best-fit administrator”), a cloud customer or user, and a cloud migration service. Three activities are performed as follows. 1) The administrator specifies a set of policies 28A and constraints 28B that will be used to evaluate the costs of provisioning specific resources such as software. 2) The repository 14 containing cloud image configuration information is created by querying or probing the cloud 10. 3) The cloud customer provides a set of target requirements 22, and system (determine best fit module 28) returns a list of recommended images.

One technique to establish a cloud migration service catalog of image contents is to instantiate cloud computing machine images by whatever means the cloud service provider makes available, such as via an image registry/catalog 11A and an API 11B, and then load discovery tools (12) onto the cloud machine instances. These discovery tools are then executed against the images, and the results are returned to populate the repository (cloud image inventory 14) containing the information discovered about the cloud images. By directly performing discovery against instantiated cloud images, the need to rely on cloud service provider-supplied advertisements (which can be limited in descriptive value as discussed above) is avoided.

One suitable type of discovery tool is described by K. Magoutis, M. V. Devarakonda, N. Joukov, N. G. Vogl, “Galapagos: Model-driven discovery of end-to-end application—storage relationships in distributed systems.” IBM Journal of Research and Development, Vol. 52, No. 4-5, 2008, Pages 367-378).

The administrator specifies the policies 28A regarding components which might be included in a target machine instance, indicating costs for operations such as component installation, removal, and upgrade, and indicating additional constraining policies (constraints 28B) such as “do not allow migration from IBM Websphere Application Server (WAS) 7 to WAS 5”. ‘WAS’ is an abbreviation herein for WebSphere® Application Server, where WebSphere® is a registered trademark of the International Business Machines Corporation.

It should be noted that the policies 28A can also represent installation order dependencies. For example, one such installation order dependency may be “install WAS before DB2 if both are needed”. During execution of the algorithm a final selected best fit can be arranged in accordance with the dependency policy or policies.

It can be further noted that it is within the scope of the exemplary embodiments of this invention to also consider software installation pre-requisites, such that if a first piece of SW is a pre-requisite for installing a second piece of SW, then the first piece of SW is also selected for installation. However, this type of operation may not be advantageous in some implementations. For example, if the first piece of SW does not appear in the list of source SW to be instantiated in the cloud, while the second piece of SW does appear, then the overall cumulative cost of the installation can be increased by the additional installation cost of the first piece of SW. Further, in some cases the first piece of SW may in turn have a pre-requisite that another piece of SW also be installed. As such, the complexity of the best fit algorithm can be significantly increased by permitting pre-requisites to be considered.

A specification of the required migration target environment is prepared in a computer-readable form. This may assisted by the application of discovery tools against proposed migration source servers, returning results to an inventory containing the source server identifiers and the information discovered about the source servers. Once the above steps have been performed, an algorithm is executed to identify the optimal target machine images to be used for the migration of a given source server workload, weighted by the policies and constraints 28A, 28B specified by the administrator.

In the exemplary embodiments improvements are made to the usability and capability of a Cloud Migration Service (CMS) which enable the migration of workloads to physical, virtual, and cloud environments. The CMS can support the migration of existing workloads to heterogeneous physical, virtual, or cloud platforms, and can automate the provisioning and configuration of the target platforms. The CMS can also support the provisioning and configuration of new physical, virtual, or cloud-based platforms.

One suitable type of CMS is described in commonly owned U.S. patent application Ser. No. 12/608,609, filed Oct. 29, 2009 and incorporated by reference herein, which enables the migration of workloads to physical, virtual, and cloud environments. Reference can also be made to C. Ward, N. Aravamundan, K. Bhattacharya, K. Cheng, R. Filepp, R. Kearney, B. Peterson, L. Shwartz, C. C. Young, “Workload Migration into Clouds—Challenges, Experiences, Opportunities” Proceedings of the 2010 IEEE International Conference on Cloud Computing (CLOUD 2010).

An aspect of the exemplary embodiments is to provide an ability to improve the selection of migration targets in cloud computing environments. A further aspect is to provide an algorithm for finding a best cost-effective way of migration to a cloud.

Cloud Image Inventory 14. The Cloud Migration Service provides customers and providers with an interface for cloud migration service registration during the design and on-boarding/initialization process. Participants provide the following information which is stored in a service catalog:

cloudID: an identifier unique to a cloud provider
cloudInterfaces: a set of constants that expose the capabilities of Cloud-provided APIs (if they exist, such as the API 11B shown in FIG. 3) such as:
Instance Management Paradigm, how an instance may be modified through the API;
Image Management Paradigm, whether an image may be uploaded through the API; and
Persistent Storage Management, whether persistent (disk) storage may be extended through the API.

A discoveryMode: identifies a mode for the discovery of the configuration of images. Discovery modes include “InstantiateAndDiscover” and “LoadDefinitions”. “InstantiateAndDiscover” indicates that periodically the CMS will run comparisons between images in the catalog 14 and images provided by the cloud provider 10. When the CMS discovers variants it acts to “InstantiateAndDiscover” newly created images and remove from the catalog 14 those images which are no longer on the cloud 10.

It may be reasonably assumed that once images are added to a cloud they will not be changed. They may be copied and those copies may be customized and stored under a different and unique id, but the existing images are not updated. The “LoadDefinitions” mode indicates that the cloud provider 10 has an interface that allows customers to download detailed configuration information about existing images in a rigorous and computer-readable format. This would obviate the need to instantiate and discover configuration information pertaining to image instances. In “InstantiateAndDiscover” mode the CMS is responsible for keeping image information up to date and could maintain currency of the information by periodic updates. In “LoadDefinitions” mode, the CMS could be responsible for contacting a cloud provider for updated image descriptions, or a cloud provider could push new image descriptions to the CMS.

### Image:

ImageID: an identifier unique to an image

cloudID: an identifier unique to a cloud computing service

softwareInstalled: a list of references to the software belonging to an image

### Software and Base Software Operations:

Software—software components that are either already installed on an image or that need to be installed. Each SW is represented by a pair of SWName (SW) and SW Version (V). For example Apache HTTP Server 2.2.3 would be represented as the pair (Apache, 2.2.3) Implicit in the above description is the notion that naming and versioning of software is compatible between the image and the target. Provisions are made for the specification of antipathies between software. If such antipathies are encountered, an uninstallation cost will be assigned.

### Base SW Operations:

install (I): install the s/w on the instance,
uninstall (R): uninstall/remove software from the instance,
update (M): upgrade the version of the software on the instance or perform ‘delete’ and ‘install’ if direct upgrade of the software is not possible.

### Policy:

### The Cost of Software Operations:

The cost of an operation can be defined as a cost function of various parameters. For example, the cost can be a combination of the time required for the migration and the cost of required people services. The cost of each operation is specified by the administrator.

There are three operations in modifying the software between a source and target: installation, removal and upgrading. For each of these operations, a function is defined to calculate the cost.

Let ƒ_{I}(S) be a function that calculates the cost of installing the software S; let ƒ_{R}(S) be a function that calculates the cost of removing (uninstalling) the software S; and let ƒ_{M}(S,S′) be a function that calculates the cost of upgrading software S to software S′, where S and S′ are functionally compatible software. Usually this implies a change from an earlier version to a later one. However, it may indicate a change to an older version, or even a change from one vendor to another. For example, an upgrade might be from MySQL to DB2. Therefore, an upgrade may be considered as being between two softwares, rather than versions thereof.

It may be the case that the upgrade path is not defined. In this event the upgrade can be accomplished by a removal of the source software and an installation of the target software. In this case then:

ƒ_{M}(S,S′)=ƒ_{R}(S)+ƒ_{I}(S′)

Another observation is that the cost of upgrading a software to itself should be zero; that is,

ƒₘ(S,S)=0

It should also be noted that for a multi-step upgrade, the following relationship applies:

ƒ_{M}(S,S′)=ƒ_{M}(S,S″)+ƒ_{M}(S″,S′).

Given the above definitions, the total cost, C of migration of software can be defined to be:

$$C = {\sum }_{i} {f}_{I} ( {S}_{i} ) + {\sum }_{i} {f}_{R} ( {S}_{i} ) + {\sum }_{i , j} fM ( {S}_{i} , {S}_{j} )$$

where the sums are taken over the software components that have to be added, removed, and upgraded, respectively. The selection of a target image is then determined by which target image yields the smallest value of C. One simplification can be to make the assumption that the cost to install or to remove a software component is the same for any version of the software.

The functions ƒ_{I} and ƒ_{R} can be implemented as table lookups, with the table rows keyed on the software name and version. The function ƒ_{M} can be implemented as a matrix look-up, where the software name defines which matrix to use, and the rows and columns are keyed by the software versions

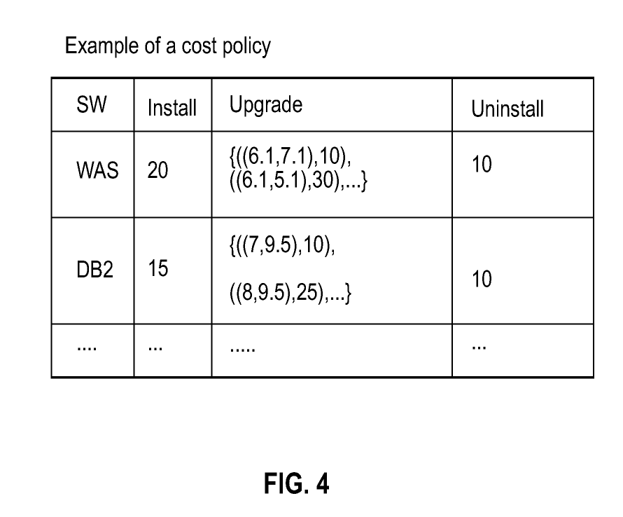

The Table depicted in FIG. 4 shows a non-limiting example of a Policy cost specification. In this example the SW in the first column is associated with the cost of Install, Upgrade, and Uninstall in the remaining columns. It can be assumed that all costs are normalized, meaning that they refer to the same “currency”.

Described now in detail is an embodiment of an algorithm executed in the system 100.

There exist at least two types of information about the targeted instance and the available cloud images: 1) hardware and 2) software information. Hardware information may include the quantitative description of virtual hardware, such as the number of CPUs, quantity of RAM, quantity of disk space, etc. In many, but not all, cases cloud providers do not allow these values to be changed since they are already predefined in the image. If the current cloud provider 10 does not allow modification of these values then the first operation of the algorithm is filtering out from the list of existing images 14 those which have insufficient values in these parameters. For example, if a specified target has four CPUs, then all images with one or two CPUs will be removed from the list of images for further consideration. Similarly, also removed from consideration are all images which have an Operating System that differs from the Operating System of the target.

The algorithm then functions to find the least costly transitioning of an existing target image to a configuration defined by the source. Assume that k is a length of SW elements in the transition required by the source, and the maximum number of existing SW elements in any target is n. The maximum number of total comparisons is n^{k}. In other words, the task is at most a polynomial of degree k. An alphanumeric ordering of the SW elements can be used to reduce number of operations required from polynomial to log-linear.

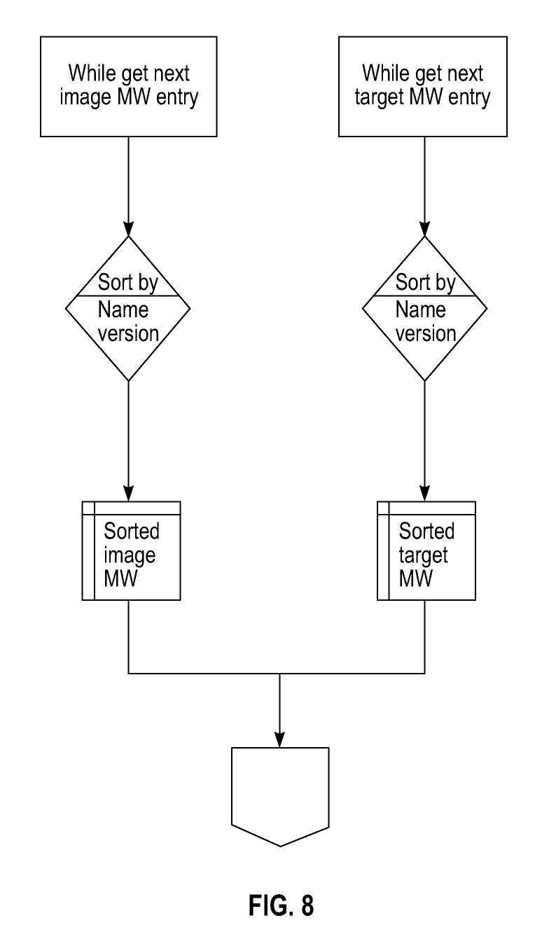

The set of software contained in each image is then ordered and specified for each target. The set of software for each target and image can be ordered (sorted) alphanumerically by the first element of the pair: software name. An established order allows comparing any two elements as follows: an element is deemed to be smaller than another element if its name begins with a letter earlier in the collating sequence than that of the first letter of the another element. Numbers are considered to be smaller than any letter. For example, an image that has Apache, WAS and DB2 installed may be represented by the following set {(Apache, 2.2.3), (DB2, 9.5), (WAS, 6.1)}. The ordering/sorting operation is depicted in FIG. 8. The algorithm relies on the results of the comparison between the respective elements in the pairs. It can be said that one element (Apache) is “smaller than” element (DB2) if the alphanumeric order of the string “Apache” occurs before the string “DB2”. For the purposes of this discussion it can also be assumed that only a single instance of software may be present on an image or a target.

The next step is the execution of a matching algorithm. Following simple logic for each condition the algorithm derives the cost (C) for the migration as the sum of all install operations for a target's software, or of all uninstall operations for an image's software.

$$C = {\sum }_{S ∈ T} {f}_{I} ( S )$$

where there is no SW on the image and SW exists on the target; and

$$C = {\sum }_{S ∈ I} {f}_{R} ( S )$$

where there are no SW requirements for target and SW exists on the image.

The same statement is true if none of the SW on the image matches the SW on the target. This condition incurs maximal migration costs since it includes costs for uninstall operations for every SW on the image and the cumulative cost of install operations for each SW required for the target. In the case where one or more SWs are common between an image and a target, the maximal cost of this SW update would be the cumulative cost of the uninstall of one version of SW and the install of a new version of SW. The situation where none of SW on the image matches exactly any of SW on the target is a worst case scenario for known matching algorithms. The algorithm described herein is an optimal algorithm for the worst case scenario.

In the next step of the algorithm a comparison between two first pairs of non-empty sets of SW is performed. The SWs are compared to understand if they are the same or if the element in the target is “smaller” than the element in the image, or vice versa. In those cases where the SWs match the versions are compared. If the versions are different the cost of version upgrade is added to the cumulative cost of migration. In cases where the SW in the target is “smaller” than the SW in the image, the cost of installation of the target's SW is added to the cumulative cost of migration. The next entry in the target's list of SW is then compared against the same SW in the image list. If this SW in the target is greater than the SW in the image then the cost of the uninstall of the image's SW is added to the cumulative cost of migration. A demonstration of the operation of the algorithm is now presented in the context of a simple example.

Target: {(a,3),(b,2),(d,1)}
Image: {(a,1),(c,2),(e,1))}

First step: compare first SWs on both lists and see that each requires software “a”, but the target has version “3” while the image has version “1”. This gives a first cost term due to an upgrade from version “1” to version “3” of software “a” as:

C₀=ƒ_{M}(a₁,a₃).

Second step: Moving to the next software in both the target and image it can be seen that have b<c. Since b is present on the target, but not on the image, the SW=b has to be installed. Therefore, the second cost factor is given by:

C₁=ƒ_{I}(b₂).

Third step: Incrementing to the next target software it can be seen that d>c which means that c is not one of the SWs on the target and it has to be removed from the image. The cost of this operation is given by:

C₂=ƒ_{R}(c₂).

Fourth step: the algorithm continues by iterating through the image's list of SWs to find that d<e. This is similar to the second step, so d has to be installed and the cost of this operation is:

C₃=ƒ_{I}(d₁).

Last step: The element e from the image is the element that has to be compared with the next element after d on the target. As there are no further elements on the target e has to be removed at a cost of:

C₄=ƒ_{R}(e₁).

The foregoing steps yield a total, cumulative cost of:

$$C = {\sum }_{i = 0}^{4} {C}_{i} .$$

As can be seen from this example exactly five comparison operations were performed: i.e., the SWs were compared four times, and once the versions of a SW that was present in both the target and the image were compared. Finally it was concluded that the last element of the image needed to be removed since the list of target elements had been exhausted. When the SWs did not match the algorithm was able to make decisions on the required operation for one of them. This means that the number of comparisons required does not exceed the sum of SW elements specified for the target and SW elements which are already built into the image. Thus, the algorithm has a linear time matching length. For example, in the case where the target has k number of SW elements and the image has l number of SW elements, the maximum length of the comparison is (k+l). The minimal length of comparison is min(k,l) and is achieved when there is no common SW between the image and the target. Indeed, considering the following example: Target: {(a,1),(b,2),(c,1)}, Image: :{(d,3),(e,2),(f,1),(g,5)}, it can be noted that iterating through the list of the target's SW will require three steps to conclude that each SW in the target has to be installed, and all SW in the image has to be uninstalled. The length of the algorithm in this case is thus min(3, 4)=3. The cost in this case is a sum of all costs for installation or removal of each SW in both lists:

$$C = {\sum }_{S ∈ T} {f}_{I} ( S ) + {\sum }_{S ∈ I} {f}_{R} ( S )$$

where T the set of all SW for the target and I is the set of SWs installed on the image.

As was noted above, the algorithm is optimal for use with the worst case scenario, and an assumption can be made that using an algorithm that is optimized for the worst case scenario contributes to usability.

FIG. 7C illustrates a logical data model 200 that is representative of the system 100. The same logical data model 200 is used to describe: 1) source server attributes, 2) required target server attributes, 3) provisionable component attributes, such as software for which installation scripts can be developed, and 4) cloud image attributes.

With respect to the data model 200, the architecture 202 is used to group server configurations 204 within an overarching type of system architecture such as IBM S390, IBM POWER, etc. The file system 206 presents mount points, sizes, permissions, types, and is related to a software FilesystemType 206A that represents types of file systems, remote or local (and contains both discovered file systems and file systems that can be provisioned). The host 208 represents a provisionable server template. The project 210 is used to group cloud images, and the request 212 is used as an entry point to requirements, and holds the source server id and the target server id.

The server configuration 204 provides hardware information such as memory, number of CPUs, machine type, architecture and source of information. The software 214 provides the software name, type, installation source location (and contains both discovered software and software that can be provisioned). A join can be used to join tables which relate, for example, software 214 with the server configuration 204.

The costs 216 represent the cost/weight for software install and uninstall, as well as upgrade/downgrade operations. The cost is dependent on the operating system, as well as the architecture 202 on which the software 214 is installed.

The constraints 218, such as the constraints 28B shown in FIG. 3, represent software relationships, including affinities and antipathies.

Target hardware and software requirements are gathered by means of the execution of the discovery tools 12 on source servers and refinement and customization of those requirements by means of the CMS which are stored to the repository 14. The inventory of cloud image attributes is populated by requesting image instances, loading and executing a discovery tool to the instances, and storing the results to the repository 14. It should be noted that by using the same discovery tools against source servers and images, and adopting the conventions of the discovery tool within the list of software, issues such as software name and version inconsistencies can be avoided.

A determination is made as to whether any affinities or antipathies exist among the target software requirements that must be taken into account, as per the constraints table 218. The outcome is the identification of conflicts among the requested software and/or more complete lists of software that should be installed on target servers. The repository 14 is then examined to determine if any software is required which cannot be provisioned. If so, any virtual image that will be considered in future steps has this restrictive software pre-installed. The repository 14 is then queried to identify cloud images that satisfy the hardware requirements, the target OS, and restrictive software from the previous step, if any. The attributes of each image are interrogated in order to determine, for each software, which operation (install, uninstall, upgrade/downgrade) may be needed. For each software which must be uninstalled, the cost of its removal is added to the total cost for that image. For each required software that requires installation or upgrade, the installation or upgrade cost is added to the image cost. The output is a sorted list specifying each virtual image and the projected workload migration cost (costs 216).

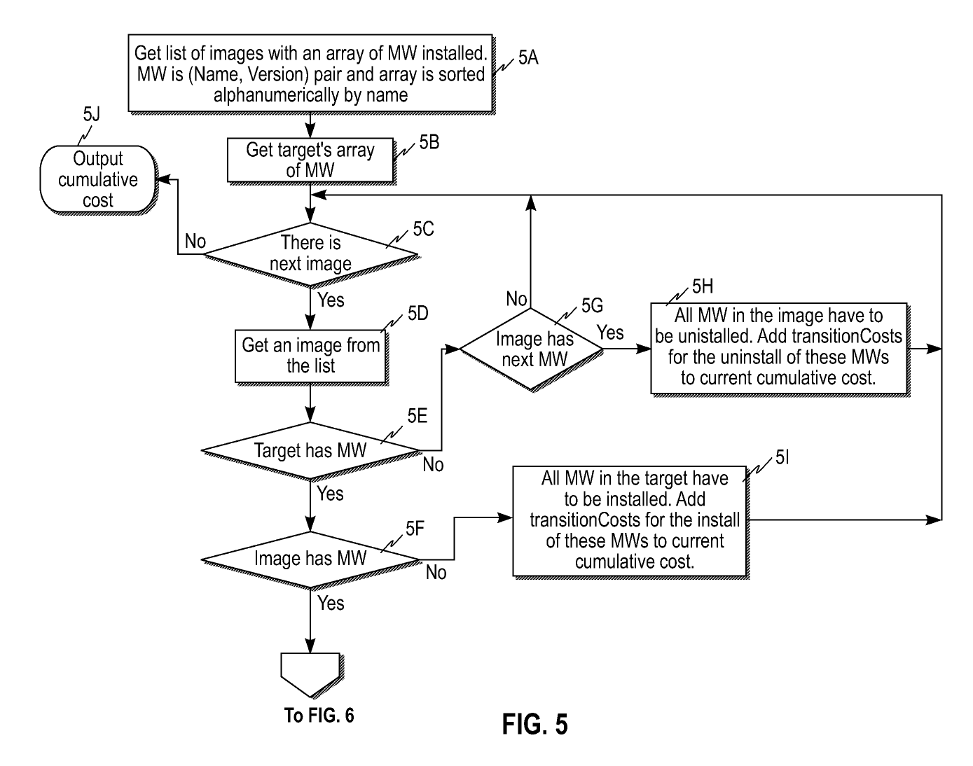

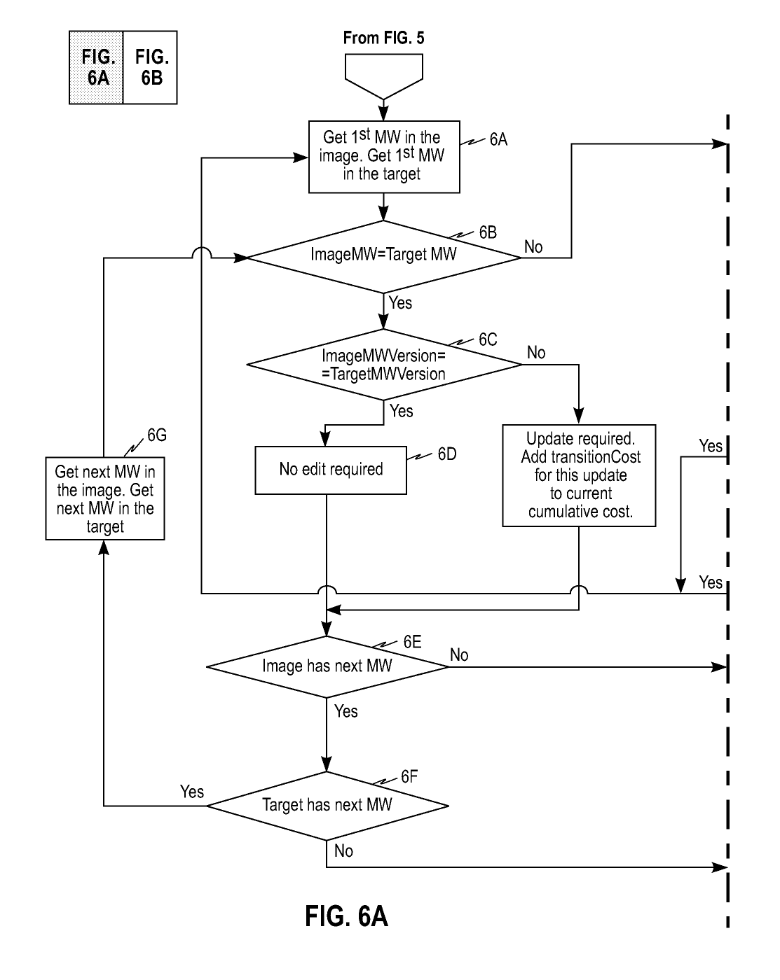

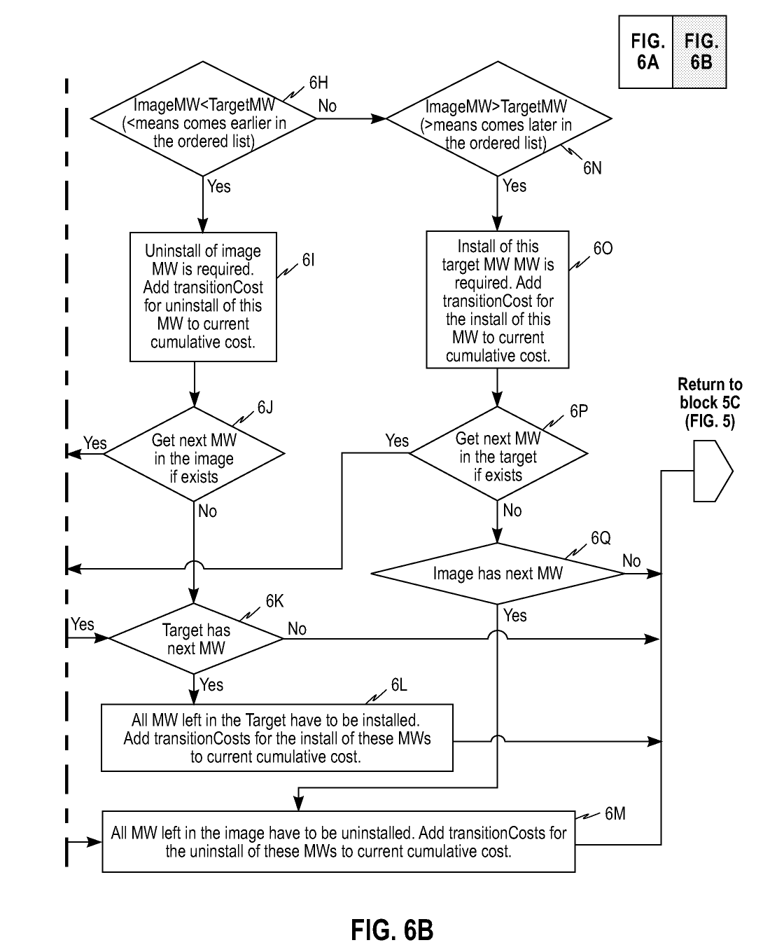

FIG. 5 describes the processing of a costing shortcut such as ‘Target (T) has no software requirements’ or ‘Image (I) has no software installed’. In FIG. 5 at Block 5A the algorithm gets a list of Images with an array of SW (also referred to herein as MW) installed, where the MW is expressed as a (Name, Version) pair (couple) and the array is sorted alphanumerically by Name as a result of the operations shown in FIG. 8. At Block 5B the target array of MW is obtained. At Block 5C a determination is made if there is a next Image. If no, the process terminates at Block 5J to output the cumulative cost. If yes (there is a next Image), the algorithm gets the Image from the array and makes a determination if the Target has MW. If yes, a determination is made if the Image has MW. If yes, control passes to the procedure depicted in FIG. 6. If the determination at Block 5E is no, control passes to Block 5G to determine if the Image has a next MW. If no, control passes back to Block 5C, else if yes control passes to Block 5H. This block indicates that all MW in the Image have to be uninstalled, and in this case the transaction costs for the uninstall of the MWs is added to the current cumulative cost. Control then passes to Block 5C to determine if there is a next Image. If the determination at Block 5F is no, control passes to Block 5I. This block indicates that all MW in the Target have to be installed, and the transaction costs for the install of the MWs is added to the current cumulative cost. Control then passes to Block 5C to determine if there is a next Image.

In FIG. 6 a comparison between two first pairs of non-empty sets of SW is performed. The algorithm compares the SWs to determine if they are the same (equal), or if the element in the Target is “smaller” than the element in the Image or vice versa. In cases where the SWs match the algorithm compares the SW versions. If the versions are different the cost of a version upgrade is added to the cumulative cost of migration. In cases where the SW in the Target is “smaller” than the SW in the Image (occurs earlier in the ordered list), an uninstall is required and the cost of installation of the Target's SW is added to the cumulative cost of the migration. The next entry in the Target's ordered list of SW is compared against the same SW in the Image ordered list. If this SW in the Target list is greater than the one in the Image list then the cost of the uninstall of the Image's SW is added to the cumulative cost of migration.

In Block 6A the algorithm gets the first MW in the Image and the first MW in the Target. At Block 6B a determination is made if the two MWs are equal. If yes, a determination is made at Block 6C if the version (V) of the Image MW is equal to the version of the Target MW. If yes, control passes to Block 6D, where it is declared that no edit is needed, then control passes to Block 6E to determine if the Image has a next MW. If yes, control passes to Block 6F to determine if the Target also has a next MW. If yes, then control passes to Block 6G to get the next MW in the Image and the next MW in the Target, and then control passes back to Block 6B to compare the two MWs to determine if they are equal.

If, at Block 6B, the determination is no control passes to Block 6H to determine if the Image MW is smaller than the target MW (does it come earlier in the ordered list). If yes control passes to Block 6I to indicate that an uninstall the Image MW is needed, and the transition cost for the uninstall is added to the current cumulative cost. Next, at Block 6J the next MW in the Image is obtained (if it exists). If it does control passes to Block 6A, otherwise control passes to Block 6K to determine if the Target has a next MW. Note that Block 6K can also be entered if the determination at Block 6E is no. If the Target does have a next MW (Block 6K) then at Block 6L all MW remaining in the Target has to be installed, and the algorithm adds the transition cost for the install of the needed MW or MWs to the current cumulative cost, and control passes back to Block 5C of FIG. 5. If the Target does not have a next MW, then the no path is taken back to Block 5C of FIG. 5. At Block 6F, if the determination is that the Target does not have a next MW then control passes to Block 6M where all MW remaining in the Image has to be uninstalled, and the algorithm adds the transition cost for the uninstall of the remaining MW or MWs to the current cumulative cost. Control then passes to Block 5C of FIG. 5.

If at Block 6H it is determined instead that the Image MW is not smaller than the target MW then control passes to Block 6N (it is implied that the Image MW is greater than Target MW and comes later in the ordered list), and then to Block 6O to indicate that an install the Target MW is needed. The transition cost for the install is added to the current cumulative cost. Next, at Block 6P the next MW in the Target is obtained (if it exists). If it does control passes to Block 6A, otherwise control passes to Block 6Q to determine if the Image has a next MW. If the Image does have a next MW then all MW remaining in the Image has to be uninstalled and the algorithm adds the transition cost for the uninstall of the Image MW or MWs to the current cumulative cost (Block 6M). If the Image does not have a next MW, then the no path is taken from Block 6Q back to Block 5C of FIG. 5.

At Block 6C, if the determination is made that Image MW version does not equal the Target MW version, control passes to Block 6R where a MW version update is indicated, and the transition cost for the update is added to the current cumulative cost. Control then passes to Block 6E.

As should be appreciated based on the foregoing discussion, an aspect of the invention is the sorting of relevant images by cost, which may be considered, along with finding the optimal images and migrating the source to the cloud using any (not necessarily the optimal) images, as being one of the goals of the invention.

FIG. 7A is a high level block diagram of the system 100 and shows its connectivity with the cloud service provider 10. An input to the system 100 is an instance of a request for migration (RFM) 102. The system 100 includes a mapping element 104. The mapping element 104 includes the algorithm 104A for mapping the RFM 102 to the cloud, as well as a self-service user interface 104B whereby the user can make, for example, a manual selection of available cloud services. The system also includes provisioning infrastructure element 106 having a self-service user interface 106A to select a provisioning mechanism. The system 100 further includes provisioning software 108 that includes software 108A to install a computer system (Target) into the images provided by the cloud 10 and to configure MW on top of the provisioned computer system. The cloud service provider 10 provides to the mapping element 104 the list of available computer systems 10A and computer system details (metadata) 10B. This information and metadata forms the basis of the catalog 14 shown in FIGS. 1B and 2. The cloud service provider 10 also includes a provision computer system element 10C to respond to the provisioning infrastructure 106A.

FIG. 7A may thus be considered as illustrating a system diagram for preparing and/or performing a migration and consolidation of at least one source application to be migrated to or consolidated in at least one heterogeneous server device according to embodiments of the present invention. The heterogeneous server device can be considered to refer to a target platform having dissimilar or different configuration with respect to the source platform.

FIG. 7B shows one exemplary embodiment of the system 100. The system 100 can include at least one data processor 120 connected with at least one graphical user interface (GUI) 122 that enables a user to interact with the system 100, such as by composing and entering the RFM 102. The GUI 122 can include any suitable types of user data display and data entry devices, including a display screen, keyboard, pointing device and/or voice recognition. Connected with the data processor 120 is also at least one memory 124 storing, among other things, the target requirements 24 and priorities 26, algorithm SW 124A and the catalog 14. The memory 124 can be constructed using any type or types of data storage devices and technologies, including but not limited to semiconductor memory, magnetic disk-based memory, optical disk-based memory and tape, as non-limiting examples of tangible, non-transitory computer-readable data storage medium. The algorithm SW 124A includes program instructions composed so as to result in the execution of the various methods described above and shown in, for example, FIGS. 1A, 5, 6 and 8. Also connected with the data processor 120 is at least one network (NW) interface (I/F) card or subsystem 126 that provides connectivity with at least one network 128, such as a local area network (LAN), wireless LAN (WLAN), and/or a wide area network (WAN) such as the Internet through which a cloud server associated with the cloud service provider 10 can be reached. As was noted above, the cloud service provider 10, for the purposes of describing the exemplary embodiments, may be considered to include at least one heterogeneous virtual server device. Bidirectional communications over the network 128 enables the catalog 14 to be populated with image-related metadata, and a desired Target system, specified by the RFM 102, to be instantiated into the cloud service provider 10 as described above.

The various embodiments described above provide a service that accumulates image configuration details and stores them in the computer-readable catalog 14, and a further service that employs an algorithm (the algorithm SW 124A) to order images per best-fit/least cost in conformance with specified requirements 24 and policies 26.

Disclosed herein has been a computer-implemented method, system and computer software for preparing a migration and consolidation of at least one source application to be migrated to, or consolidated in, at least one heterogeneous virtual server device managed within a cloud computing environment. The computer-implemented method, system and computer software includes collecting first metadata of at least one source platform component and at least one prospective target platform component, selecting at least one prospective target platform component based on one or more of: an evaluation of at least one source platform component and a requirement of the at least one source application, wherein the source platform component refers to an individual dependency that the at least one source application has upon hardware, software, or at least one attribute of the hardware and software. The prospective target platform component refers to an individual software, hardware or attributes of the individual software and hardware to be provisioned for at least one server device. The computer-implemented method, system and computer software further includes preparing and configuring an instance of a final target platform within the cloud computing environment based on the first metadata and the second metadata, where the final target platform refers to a sum of dependencies that the final target application has upon hardware and/or software. A final target application refers to an application that exists after the migration and consolidation into the cloud computing environment. The computer-implemented method, system and computer software further includes saving the instance of the final target platform within the cloud computing environment as a virtual image within the cloud computing environment.

The use of the computer-implemented method, system and computer software improves application migration from one or a plurality of computer systems to a set of computer systems offered by a cloud service provider as cloud services.

The use of the computer-implemented method, system and computer software provides an ability to distinguish between infrastructure provisioning and software provisioning, where each operation can be performed independently, and where software provisioning uses a result of the infrastructure provisioning.

The computer-implemented method, system and computer software provide an at least one algorithm that matches a RFM document to a set of computer systems of a cloud service provider.

An aspect the computer-implemented method, system and computer software is an integrated user interface that allows users to select from different migration mechanisms (e.g. cloud vs. non-cloud) and provide the possibility to view metadata on the provisioning process for decision support (e.g., speed and/or accuracy).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As was noted above with respect to FIG. 7B, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the various Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As such, various modifications and adaptations may become apparent to those skilled in the relevant arts in view of the foregoing description, when read in conjunction with the accompanying drawings and the appended claims. As but some examples, the use of other similar or equivalent computer processing systems and algorithms may be used by those skilled in the art. However, all such and similar modifications of the teachings of this invention will still fall within the scope of this invention.

What is claimed is:

1. A computer-implemented method for migration of a source machine instance to a target machine instance of least one heterogeneous virtual server device managed within a cloud computing environment, the method comprising:
discovering machine images of a cloud service provider and storing results in a computer-readable catalog containing cloud metadata comprised of machine image identifiers and information discovered about the machine images;
in response to a request for migration document that comprises a specification of a required migration target machine instance, specifying weight/priority information for components to be included in the target machine instance, where the weight information indicates weights for operations comprising component installation, component removal and component upgrade in the target machine instance; and
executing a best fit matching algorithm to examine the catalog in accordance with the weight/priority information to identify optimal machine images to be used for the migration of the source machine instance to the target machine instance.

2. The computer-implemented method of claim 1, where executing the best fit matching algorithm derives a cumulative cost for implementing the target machine instance based on specified weight/priority information.

3. The computer-implemented method of claim 2, where executing the best fit matching algorithm considers software components that are either already installed on a particular machine image or that need to be installed on the particular machine image, where each software component is represented by a software name and software version pair, and where the cumulative cost comprises at least one of a cost to install software on the particular machine image, uninstall software from the particular machine image and upgrade or downgrade the software version on the particular machine image.

4. The computer-implemented method of claim 1, where executing the best fit matching algorithm compares a sorted list of machine image software components from the catalog and a sorted list of software components from the request for migration document, and derives a cumulative cost for implementing the sorted list of software components from the request for migration document as a particular instance of the machine image software components, where each software component is represented by a software name and software version pair, and where the cumulative cost comprises at least one of a cost to install software on the particular machine image, uninstall software from the particular machine image and upgrade or downgrade the software version on the particular machine image.

5. The computer-implemented method of claim 4, where each list is sorted alphabetically by software name.

6. The computer-implemented method of claim 1, where the request for migration document comprises a qualitative description of certain parameters needed for the target machine instance, further comprising filtering out from the catalog those machine images having insufficient values in of the certain parameters, and further comprising during execution of the method a step of sorting remaining relevant images by cost.

7. The computer-implemented method of claim 6, where the certain parameters comprise at least one of hardware parameters and operating system parameters.

8. A computer-readable storage medium containing program instructions that, when executed by at least one data processor, result in performing operations to migrate a source machine instance to a target machine instance of least one heterogeneous virtual server device managed within a cloud computing environment, the operations comprising:
discovering machine images of a cloud service provider and storing results in a computer-readable catalog containing cloud metadata comprised of machine image identifiers and information discovered about the machine images;
in response to a request for migration document that comprises a specification of a required migration target machine instance, specifying weight/priority information for components to be included in the target machine instance, where the weight information indicates weights for operations comprising component installation, component removal and component upgrade in the target machine instance; and
executing a best fit matching algorithm to examine the catalog in accordance with the weight/priority information to identify optimal machine images to be used for the migration of the source machine instance to the target machine instance.

9. The computer-readable storage medium of claim 8, where executing the best fit matching algorithm derives a cumulative cost for implementing the target machine instance based on specified weight/priority information.

10. The computer-readable storage medium of claim 9, where executing the best fit matching algorithm considers software components that are either already installed on a particular machine image or that need to be installed on the particular machine image, where each software component is represented by a software name and software version pair, and where the cumulative cost comprises at least one of a cost to install software on the particular machine image, uninstall software from the particular machine image and upgrade or downgrade the software version on the particular machine image.

11. The computer-readable storage medium of claim 8, where executing the best fit matching algorithm compares a sorted list of machine image software components from the catalog and a sorted list of software components from the request for migration document, and derives a cumulative cost for implementing the sorted list of software components from the request for migration document as a particular instance of the machine image software components, where each software component is represented by a software name and software version pair, and where the cumulative cost comprises at least one of a cost to install software on the particular machine image, uninstall software from the particular machine image and upgrade or downgrade the software version on the particular machine image.

12. The computer-readable storage medium of claim 11, where each list is sorted alphabetically by software name.

13. The computer-readable storage medium of claim 8, where the request for migration document comprises a qualitative description of certain parameters needed for the target machine instance, further comprising filtering out from the catalog those machine images having insufficient values in of the certain parameters, and further comprising during execution of the program instructions an operation of sorting remaining relevant images by cost.

14. The computer-readable storage medium of claim 13, where the certain parameters comprise at least one of hardware parameters and operating system parameters.

15. A system configured to migrate a source machine instance to a target machine instance of least one heterogeneous virtual server device managed within a cloud computing environment, comprising:
at least one computer-readable storage medium storing computer program instructions; and
at least one data processor readably coupled to the at least one computer-readable storage medium, where execution of the computer program instructions by the at least one data processor causes the at least one data processor to discover machine images of a cloud service provider and store results in a computer-readable catalog containing cloud metadata comprised of machine image identifiers and information discovered about the machine images; the at least one data processor being responsive to a request for migration document that comprises a specification of a required migration target machine instance, to specify weight/priority information for components to be included in the target machine instance, where the weight information indicates weights for operations comprising component installation, component removal and component upgrade in the target machine instance, the at least one data processor further configured to execute a best fit matching algorithm to examine the catalog in accordance with the weight/priority information to identify optimal machine images to be used for the migration of the source machine instance to the target machine instance.

16. The system of claim 15, where when executing the best fit matching algorithm the at least one data processor derives a cumulative cost for implementing the target machine instance based on specified weight/priority information.

17. The system of claim 16, where when executing the best fit matching algorithm the at least one data processor considers software components that are either already installed on a particular machine image or that need to be installed on the particular machine image, where each software component is represented by a software name and software version pair, and where the cumulative cost comprises at least one of a cost to install software on the particular machine image, uninstall software from the particular machine image and upgrade or downgrade the software version on the particular machine image.

18. The system of claim 15, where when executing the best fit matching algorithm the at least one data processor compares a sorted list of machine image software components from the catalog and a sorted list of software components from the request for migration document, and derives a cumulative cost for implementing the sorted list of software components from the request for migration document as a particular instance of the machine image software components, where each software component is represented by a software name and software version pair, and where the cumulative cost comprises at least one of a cost to install software on the particular machine image, uninstall software from the particular machine image and upgrade or downgrade the software version on the particular machine image.

19. The system of claim 18, where each list is sorted alphabetically by software name.

20. The system of claim 15, where the request for migration document comprises a qualitative description of certain parameters needed for the target machine instance, and where the at least one data processor is further configured to filter out from the catalog those machine images having insufficient values in of the certain parameters, and to sort remaining relevant images by cost.

21. The system of claim 20, where the certain parameters comprise at least one of hardware parameters and operating system parameters.

22. A method to migrate a target machine instance to a cloud computing environment, comprising:
discovering machine image components of machine images of a cloud service provider and storing results in a computer-readable inventory;
removing from consideration those machine images having hardware and software that is incompatible with the target machine instance; and
executing a best fit matching algorithm to compare a sorted list of machine image software components for a particular machine image and a sorted list of software components of the target machine instance to derive a cumulative cost for implementing the sorted list of target machine software components as a particular instance of the machine image software components.

23. The method of claim 22, where each software component is represented by a software name and software version pair, and where the cumulative cost comprises at least one of a cost to install software on the particular machine image, uninstall software from the particular machine image and upgrade or downgrade the software version on the particular machine image.

24. The method of claim 22, where each list is sorted alphabetically by software name.

25. The method of claim 22, further comprising selecting a particular machine image to which to migrate the target machine instance as the machine image having a lowest cumulative cost as compared to the cumulative cost of other machine images.

26. The method of claim 22, further comprising ordering a list of relevant machine images by cumulative migration cost.
